(19) United States
(12) Patent Application Publication
(10) Pub. No.: US 2022/0106193 A1
(43) Pub. Date: Apr. 7, 2022

(54) AMMONIA SYNTHESIS CATALYST, METHOD FOR PRODUCING AMMONIA SYNTHESIS CATALYST, AND METHOD FOR SYNTHESIZING AMMONIA

(71) Applicant: TOYOTA JIDOSHA KABUSHIKI KAISHA, Toyota-shi Aichi-ken (JP)

(72) Inventors: Masashi Kikugawa, Nagakute-shi Aichi (JP); Akinori Satou, Mishima-shi Shizuoka (JP); Tetsuya Namba, Koriyama-shi Fukushima (JP); Hideyuki Matsumoto, Suginami-ku Tokyo (JP)

(73) Assignee: TOYOTA JIDOSHA KABUSHIKI KAISHA, Toyota-shi Aichi-ken (JP)

(21) Appl. No.: 17/493,080

(22) Filed: Oct. 4, 2021

(30) Foreign Application Priority Data
Oct. 6, 2020 (JP) 2020-169151

(51) Int. Cl. C01C 1/04; B01J 23/10; B01J 23/00; B01J 23/46; B01J 37/08; B01J 37/03; B01J 37/02; B01J 37/04; B01J 37/18

(52) U.S. Cl. CPC C01C 1/0411; B01J 23/10; B01J 23/002; B01J 23/462; B01J 37/18; B01J 37/031; B01J 37/0207; B01J 37/04; B01J 37/082

(57) ABSTRACT

The present disclosure provides an ammonia synthesis catalyst including a composite oxide support containing cerium and praseodymium; and ruthenium supported on the composite oxide support, wherein a molar ratio of cerium to praseodymium ([cerium]/[praseodymium]) contained in the composite oxide support is 20/80 to 90/10.

### CROSS REFERENCE TO RELATED APPLICATION

This application claims the benefit of and priority to Japanese Patent Application No. 2020-169151 filed on Oct. 6, 2020, the entire contents of which are herein incorporated by reference.

### BACKGROUND

### Technical Field

The present disclosure relates to an ammonia synthesis catalyst, a method for producing an ammonia synthesis catalyst, and a method for synthesizing ammonia.

### Related Background Art

Recently, ammonia has been attracting attention as a component that can be applied to uses such as energy carriers for hydrogen energy. Conventionally, the Haber-Bosch process, which uses an iron-based catalyst as the catalyst, has been used industrially as a method of synthesizing such ammonia, and in recent years, various types of ammonia synthesis catalysts have been studied with the aim of synthesizing ammonia under milder conditions than those of the Haber-Bosch process.

For example, Japanese Unexamined Patent Application Publication No. 2016-155123 (Patent Document 1) discloses an ammonia synthesis catalyst in which ruthenium is supported in a layered manner on a praseodymium oxide support. In addition, Japanese Unexamined Patent Application Publication No. 2017-1037 (Patent Document 2) discloses a catalyst composition for ammonia production, the composition obtained by mixing: a first component that includes a support with a lanthanide-containing compound as a forming material and ruthenium, a ruthenium-containing alloy, or a ruthenium-containing compound supported on the support; and a second component that is an alkali metal-containing compound and/or a porous metal complex. In addition, Japanese Unexamined Patent Application Publication No. 2017-18907 (Patent Document 3) discloses, in its Examples 1 to 3, a catalyst composition obtained by hydrogen reduction to a frictional mixture composition of cesium carbonate and a ruthenium-praseodymium oxide composition, with ruthenium supported on praseodymium oxide. However, catalysts and catalyst compositions such as those disclosed in Patent Documents 1 to 3 are not sufficient in terms of ammonia production activity. Note that although Patent Document 2 describes a support with a lanthanide-containing compound being the forming material as the support for the first component, the support for the first component that is actually demonstrated in the examples is Pr₆O₁₁, CeO₂, or La₂O₃, and the effects and the like of the first component using other supports are not specifically demonstrated.

Furthermore, in LIN Jianxin et al., “Effects of Pr Doping on Structure and Catalytic Performance of Ru/CeO₂ Catalyst for Ammonia Synthesis,” Chinese Journal of Catalysis, 2012, vol. 33, No. 3, pp. 536 to 542 (Non-Patent Document 1), the use of catalysts in which Ru is supported on a support (CeO₂ (alone) or CeO₂—PrO₂) obtained by adding Pr to CeO₂ so that the content (amount added) of Pr (metal) to the metal component in the support is 0 mol %, 1 mol %, 2 mol %, 4 mol %, and 6 mol %, is considered for the synthesis of ammonia, and it has been reported that catalysts with Ru supported on a support obtained by adding Pr to CeO₂ (CeO₂—PrO₂) show higher activity than catalysts with Ru supported on CeO₂ (alone) (Ru/CeO₂) and that the amount of ammonia produced reaches its maximum when the content (amount added) of Pr is 4 mol %. However, even in catalysts such as those described in the above Non-Patent Document 1, the ammonia production activity is not sufficient.

### SUMMARY

The present disclosure has been made in view of the above-mentioned problems of the related art, and an object thereof is to provide an ammonia synthesis catalyst having excellent ammonia production activity and enabling more efficient synthesis of ammonia, a method for producing an ammonia synthesis catalyst capable of efficiently producing the ammonia synthesis catalyst, and a method for synthesizing ammonia using the ammonia synthesis catalyst.

The present inventors have made earnest studies to achieve the above object, and have found as a result that when the ammonia synthesis catalyst comprises: a composite oxide support containing cerium and praseodymium; and ruthenium supported on the composite oxide support, and a molar ratio of cerium to praseodymium ([cerium]/[praseodymium]) contained in the composite oxide support is 20/80 to 90/10, the ammonia production activity of the catalyst becomes excellent, and ammonia can be synthesized more efficiently. Thus, the present disclosure has been completed.

Specifically, an ammonia synthesis catalyst of the present disclosure comprises:

a composite oxide support containing cerium and praseodymium; and

ruthenium supported on the composite oxide support, wherein

a molar ratio of cerium to praseodymium ([cerium]/[praseodymium]) contained in the composite oxide support is 20/80 to 90/10.

In embodiments of the ammonia synthesis catalyst of the present disclosure, the molar ratio of cerium to praseodymium ([cerium]/[praseodymium]) contained in the composite oxide support is 25/75 to 75/25.

In addition, a method for producing an ammonia synthesis catalyst of the present disclosure is a method comprising:

obtaining a composite oxide support containing cerium and praseodymium by using a solution for forming a composite oxide support containing a cerium salt and a praseodymium salt in a proportion such that a molar ratio of cerium to praseodymium ([cerium]/[praseodymium]) is 20/80 to 90/10, producing a precipitate containing cerium and praseodymium in the solution by a coprecipitation method, and then calcinating the precipitate; and

obtaining the ammonia synthesis catalyst of the present disclosure by supporting ruthenium on the composite oxide support using a solution of a ruthenium salt, and then calcinating the support under a reducing gas atmosphere or an inert gas atmosphere.

In embodiments of the method for producing an ammonia synthesis catalyst of the present disclosure, the solution for forming a composite oxide support further contains urea in a molar amount that is 8 to 20 times a total molar amount of cerium and praseodymium contained in the solution.

Further, a method for synthesizing ammonia of the present disclosure is a method comprising: synthesizing ammonia by bringing a gas containing hydrogen and nitrogen into contact with the ammonia synthesis catalyst of the present disclosure.

Note that although the reason why the above object is achieved by the present disclosure is not always clear, the present inventors presume as follows. Specifically, first, in the ammonia synthesis catalyst of the present disclosure, a composite oxide support containing cerium (Ce) and praseodymium (Pr) is used as the support. Here, since praseodymium oxide is more easily reduced than cerium oxide, it is considered that the oxygen shared by cerium and praseodymium in the composite oxide support is in a state in which electrons are more easily attracted from praseodymium than cerium (a state in which it is easily reduced by praseodymium). Thus, it is considered that the cerium in the composite oxide support is in a state of being more easily reduced. Therefore, in such a composite oxide support, the valence of Ce tends to change from tetravalent to trivalent due to the presence of Pr in the support, and the reducing property of CeO₂ in the support is further improved. Here, in the present disclosure, the molar ratio of Ce and Pr (Ce/Pr ratio) contained in the composite oxide support is 20/80 to 90/10. As described above, in the composite oxide support according to the present disclosure, Pr is contained at 10 mol % to 80 mol % based on the total molar amount (gross molar amount) of Ce and Pr in the composite oxide support. Since Pr is contained in such a proportion, in the present disclosure, while keeping the amount of Ce in the composite oxide sufficient, it is possible to sufficiently and efficiently induce the effect of changing the valence of Ce from tetravalent to trivalent in the composite oxide. As a result, in the ammonia synthesis catalyst of the present disclosure, it is possible to more efficiently induce electron donation from trivalent Ce to the active species Ru, and it is possible to more efficiently activate nitrogen when nitrogen is brought into contact with the Ru. Therefore, the present inventors presume that the reaction between nitrogen and hydrogen is promoted and the production of ammonia proceeds more efficiently. As described above, the present inventors presume that the present disclosure makes it possible to sufficiently and efficiently induce the effect of changing the valence of Ce from tetravalent to trivalent based on the composition of the composite oxide support, which enables more efficient electron donation to the active species Ru, resulting in higher ammonia production activity and more efficient ammonia synthesis.

The present disclosure makes it possible to provide an ammonia synthesis catalyst having excellent ammonia production activity and enabling more efficient synthesis of ammonia, a method for producing an ammonia synthesis catalyst capable of efficiently producing the ammonia synthesis catalyst, and a method for synthesizing ammonia using the ammonia synthesis catalyst.

### BRIEF DESCRIPTION OF THE DRAWINGS

FIG. 1 is a graph showing the ammonia production rates for the catalysts obtained in Examples 1 to 4 and Comparative Examples 1 to 6.

FIG. 2 shows the relationship between the content (mol %) of praseodymium in the composite oxide support used in the catalysts obtained in Examples 1 to 4 and Comparative Examples 1 to 6 and the ammonia production rates for the catalysts obtained in Examples 1 to 4 and Comparative Examples 1 to 6.

### DETAILED DESCRIPTION

Hereinafter, embodiments of the present disclosure will be described in detail.

[Ammonia Synthesis Catalyst]

An ammonia synthesis catalyst of the present disclosure comprises: a composite oxide support containing cerium and praseodymium; and ruthenium supported on the composite oxide support, and a molar ratio of cerium to praseodymium ([cerium]/[praseodymium]) contained in the composite oxide support is 20/80 to 90/10.

The composite oxide support according to the present disclosure is a composite oxide support containing cerium and praseodymium. Such a composite oxide support may contain cerium and praseodymium, and may further contain additional known components (additional metals) used as catalyst supports in the field of ammonia synthesis. In such a composite oxide support, the content of cerium and praseodymium based on all the metal components contained in the composite oxide support is in embodiments, 70 to 100 mol %, in embodiments, 80 to 100 mol %, and in embodiments, 90 to 100 mol %, in terms of metal.

Further, in the composite oxide support according to the present disclosure, the molar ratio of cerium to praseodymium ([cerium]/[praseodymium]) contained in the composite oxide support needs to be 20/80 to 90/10. In relation to such a molar ratio, when the content ratio of cerium is less than the lower limit, the amount of cerium that donates electrons to the active species Ru decreases, so that the catalytic activity is lowered. Meanwhile, when the content ratio of cerium exceeds the upper limit in the molar ratio, cerium cannot be sufficiently reduced, so that electrons cannot be sufficiently donated from cerium to the active species Ru, and the catalytic activity is lowered. In addition, from the same viewpoint, the molar ratio of cerium to praseodymium ([cerium]/[praseodymium]) contained in such a composite oxide support is, in embodiments, 25/75 to 80/20, and in embodiments, 25/75 to 75/25. Note that the “molar ratio of cerium to praseodymium” as used herein refers to the molar ratio of cerium and praseodymium, which are metal components constituting the composite oxide support, in terms of metal.

In addition, when such a composite oxide support contains an additional metal other than cerium and praseodymium, the additional metal is not particularly limited, and it is possible to appropriately use any metal that can be used as a catalyst support in the field of ammonia synthesis. Examples of the additional metal include Sc, Y, and La.

Additionally, the shape of such a composite oxide support is not particularly limited, and may be a conventionally known shape such as a ring shape, a spherical shape, a columnar shape, a particle shape, or a pellet shape. Note that from the viewpoint that Ru can be contained in a larger amount in a highly dispersible state, in embodiments a particle-shaped one is used. When such a composite oxide support is in a particle shape, the average particle diameter of the support is, in embodiments, 0.1 to 100 μm.

Further, the specific surface area of such a composite oxide support is not particularly limited, but is, in embodiments, 1 to 300 m²/g, and in embodiments, 10 to 200 m²/g. When the specific surface area is less than the lower limit, the dispersibility of the supported Ru tends to decrease, and the catalytic performance (ammonia production activity) tends to decrease. Meanwhile, when the upper limit is exceeded, the heat resistance of the support decreases, so that the catalytic performance tends to decrease. In addition, such a specific surface area can be calculated as a BET specific surface area from the adsorption isotherm using the BET isotherm adsorption formula. Note that the BET specific surface area can be obtained by using a commercially available device.

Note that as a method for producing such a composite oxide support, it is contemplated to employ a method for producing a composite oxide support by the same step as the “obtaining a composite oxide support containing cerium and praseodymium” in the method for producing an ammonia synthesis catalyst of the present disclosure, which will be described later. Additionally, it is contemplated that the composite oxide support is produced by using a cerium salt and a praseodymium salt to produce a precipitate by the coprecipitation meth and then calcining the precipitate. When such a composite oxide support obtained by the coprecipitation method is used, the uniformity of cerium and praseodymium in the support becomes higher, and it becomes possible to obtain enhanced catalytic activity.

Further, in the ammonia synthesis catalyst of the present disclosure, ruthenium is supported on the composite oxide support. The amount of ruthenium supported is not particularly limited, but is, in embodiments, 0.5 to 10 parts by mass (in embodiments, 1 to 5 parts by mass) in terms of metal (metal equivalent) of ruthenium based on 100 parts by mass of the aforementioned composite oxide support. When the amount of ruthenium supported is less than the lower limit, it tends to be difficult to obtain sufficiently high ammonia production activity. Meanwhile, when it exceeds the upper limit, depending on the use environment, sintering of ruthenium tends to occur and the degree of dispersion of ruthenium, the active site, tends to decrease, making it difficult to obtain an effect corresponding to the amount of ruthenium used, which tends to be disadvantageous in terms of cost.

The particle diameter (average particle diameter) of ruthenium supported on the composite oxide support is not particularly limited, but is, in embodiments, 0.5 to 100 nm (in embodiments, 1 to 50 nm). When the particle diameter of ruthenium is less than the lower limit, it tends to be difficult to use it as a metal state. Meanwhile, when the upper limit is exceeded, the amount of the active site as a catalyst tends to decrease significantly.

In addition, in the ammonia synthesis catalyst of the present disclosure, the aforementioned composite oxide support may be supported as appropriate with additional known supporting components (such as additives) that are used by being supported on a support in the field of ammonia synthesis catalysts, as long as the effects of the present disclosure are not impaired. Examples of the additional supporting components include Sc, Y, and La.

Further, the form of the ammonia synthesis catalyst is not limited. For example, it may be a form such as a honeycomb-shaped monolithic catalyst and a pellet-shaped pellet catalyst. Furthermore, the form may be a powdered one that is directly placed as it is at the desired location. The method for obtaining such various forms of the ammonia synthesis catalyst is not particularly limited, and such various forms of the ammonia synthesis catalyst can be produced by appropriately employing a known molding method or the like to the ammonia synthesis catalyst. For example, one may appropriately employ a method of molding an ammonia synthesis catalyst into pellets to obtain a pellet-shaped ammonia synthesis catalyst, a method of coating a catalyst base material with an ammonia synthesis catalyst to obtain an ammonia synthesis catalyst in a form coated (fixed) on a catalyst base material, and the like. Note that the catalyst base material is not particularly limited and can be appropriately selected depending on the method of using the ammonia synthesis catalyst and the like. For example, a monolithic base material, a pellet-shaped base material, a plate-shaped base material, and the like can be employed in embodiments. Further, the material of such a catalyst base material is also not particularly limited either. For example, a base material made of ceramics such as cordierite, silicon carbide, or mullite, and a base material made of a metal such as stainless steel containing chromium and aluminum are employed in embodiments. Moreover, the ammonia synthesis catalyst of the present disclosure may be used in combination with additional catalysts.

Further, the method for producing such an ammonia synthesis catalyst of the present disclosure is not particularly limited, and since the ammonia synthesis catalyst of the present disclosure can be formed more efficiently, it is contemplated to employ the method for producing an ammonia synthesis catalyst of the present disclosure described later.

[Method for Producing Ammonia Synthesis Catalyst]

A method for producing an ammonia synthesis catalyst of the present disclosure is a method comprising: obtaining a composite oxide support containing cerium and praseodymium by using a solution for forming a composite oxide support containing a cerium salt and a praseodymium salt in a proportion such that a molar ratio of cerium to praseodymium ([cerium]/[praseodymium]) is 20/80 to 90/10, producing a precipitate containing cerium and praseodymium in the solution by a coprecipitation method, and then calcinating the precipitate (hereinafter simply referred to as the “support preparation step” in some cases); and obtaining the ammonia synthesis catalyst of the present disclosure by supporting ruthenium on the composite oxide support using a solution of a ruthenium salt, and then calcinating the support under a reducing gas atmosphere or an inert gas atmosphere (hereinafter simply referred to as the “catalyst preparation step” in some cases).

<Support Preparation Step>

The method for producing an ammonia synthesis catalyst of the present disclosure first obtains a composite oxide support containing cerium and praseodymium by using a solution for forming a composite oxide support containing a cerium salt and a praseodymium salt in a proportion such that a molar ratio of cerium to praseodymium ([cerium]/[praseodymium]) is 20/80 to 90/10, producing a precipitate containing cerium and praseodymium in the solution by a coprecipitation method, and then calcinating the precipitate (support preparation step).

The cerium salt used in such a support preparation step is not particularly limited, and it is possible to appropriately use sulfates, nitrates, chlorides, acetates, various complexes, and the like, and examples thereof include cerium nitrate, diammonium cerium nitrate, and cerium acetate. Further, the praseodymium salt is not particularly limited, and it is possible to appropriately use sulfates, nitrates, chlorides, acetates, various complexes, and the like, and examples thereof include praseodymium nitrate and praseodymium acetate.

Further, the solvent of the solution for forming a composite oxide support containing the cerium salt and the praseodymium salt is not particularly limited, and it is possible to use those capable of dissolving the cerium salt and the praseodymium salt to form these ions (cerium ions and praseodymium ions). Examples of such a solvent include water and alcohol, and, in embodiments, water can be used from the viewpoint of cost and safety.

Further, such a solution for forming a composite oxide support contains the cerium salt and the praseodymium salt in a proportion such that the molar ratio of cerium to praseodymium ([cerium]/[praseodymium]) is 20/80 to 90/10 (in embodiments, 25/75 to 80/20, and in embodiments, 25/75 to 75/25). By using the aforementioned cerium salt and praseodymium salt in such a molar ratio, the resulting composite oxide support can be made into a composite oxide support containing cerium and praseodymium, in which the molar ratio of cerium to praseodymium ([cerium]/[praseodymium]) is 20/80 to 90/10 (in embodiments, 25/75 to 80/20, and in embodiments, 25/75 to 75/25). As described above, the molar ratio of cerium to praseodymium in the solution for forming a composite oxide support can basically be directly reflected in the molar ratio of cerium to praseodymium in the resulting composite oxide support. Therefore, it is contemplated to set the molar ratio of Ce to Pr in the solution within the aforementioned proportion according to the design of the composite oxide support.

Further, the support preparation step using such a solution for forming a composite oxide support produces a precipitate containing cerium and praseodymium in the solution by a coprecipitation method. The coprecipitation method may be any method as long as it can coprecipitate cerium ions and praseodymium ions in the solution for forming a composite oxide support, and is not particularly limited, and known methods can be appropriately employed.

Further, in the present disclosure, from the viewpoint that particles having a more uniform size, shape, and composition can be easily produced, it is contemplated to employ, as the coprecipitation method, a method of producing a precipitate (coprecipitate) containing cerium and praseodymium by using the solution for forming a composite oxide support further containing urea, and heating the solution. As above, by heating the aforementioned solution for forming a composite oxide support further containing urea, the urea is hydrolyzed to produce ammonia and carbon dioxide (CO₂) in the solution, which makes it possible to produce a more uniform precipitate, and to obtain a precipitate in which cerium and praseodymium are more dispersed and mixed with each other in a finer state. As described above, from the viewpoint of producing a more uniform precipitate, in embodiments, the solution for forming a composite oxide support is a solution further containing urea. Further, it is contemplated that the solution for forming a composite oxide support further contains urea in a molar amount that is 8 to 20 times (in embodiments, 10 to 15 times) a total molar amount of cerium and praseodymium contained in the solution. When the content ratio of urea is less than the lower limit, it becomes difficult to precipitate all the cerium ions and praseodymium ions in the solution for forming a composite oxide support, and it tends to be difficult to form a composite oxide support of a desired design. Meanwhile, even when the upper limit is exceeded, no further effect by adding urea cannot be obtained, and the economic efficiency tends to decrease.

Further, in the case of employing a method of heating the solution for forming a composite oxide support containing urea when producing the precipitate (coprecipitate), the heating temperature is in embodiments, 90° C. or higher, and in embodiments, 90 to 98° C. When the heating temperature is less than the lower limit, urea is not hydrolyzed and a precipitate cannot be produced. Further, when the solution for forming a composite oxide support containing urea is heated in this way, from the viewpoint of obtaining a precipitate in which cerium and praseodymium are dispersed more uniformly, it is contemplated to heat the solution for forming a composite oxide support with stirring to produce a precipitate (coprecipitate) containing cerium and praseodymium. Further, in the case of heating the solution for forming a composite oxide support containing urea, the heating time (time of reaction for producing a precipitate, and stirring and heating time in the case of stirring) is not particularly limited, but is, in embodiments, 5 to 12 hours (in embodiments, 5 to 8 hours). When the heating time is less than the lower limit, the precipitate cannot be sufficiently produced, and it tends to be difficult to form a composite oxide support of the desired design.

Further, the composite oxide support preparation step produces a precipitate by the coprecipitation method as described above and then calcinate the precipitate. Such a calcination step makes it possible to prepare a composite oxide support containing cerium and praseodymium. The calcination temperature in such a calcination step is, in embodiments, 650 to 800° C., and in embodiments, 700 to 800° C. In addition, the calcination time is, in embodiments, 3 to 20 hours, and in embodiments, 5 to 10 hours. If the calcination temperature or calcination time is less than the lower limit, the carbonates and the like of cerium and praseodymium that can be contained in the precipitate cannot be sufficiently decomposed, and there is a tendency that a desired composite oxide support containing cerium and praseodymium cannot be efficiently obtained. Meanwhile, when the calcination temperature or calcination time exceeds the upper limit, particles of the composite oxide containing cerium and praseodymium undergo particle growth, resulting in a small specific surface area. As a result, when supporting Ru, it becomes impossible to sufficiently disperse and support Ru, and it tends to be difficult to obtain sufficient catalytic performance (catalytic activity). Additionally, the atmosphere in such a calcination step is not particularly limited, but in embodiments, the atmosphere may be an oxidizing atmosphere (for example, in the air) or an inert gas (for example, N₂) atmosphere.

Note that in the support preparation step, from the viewpoint of uniform heating (decomposition), it is contemplated to perform a treatment of drying the precipitate before performing the calcination step. The method of such a drying treatment is not particularly limited, but it is contemplated to employ a method of allowing it to stand in the air at 70° C. to 200° C. for 5 to 20 hours.

<Catalyst Preparation Step>

The method for producing an ammonia synthesis catalyst of the present disclosure, after obtaining a composite oxide support as described above, obtains the ammonia synthesis catalyst of the present disclosure by supporting ruthenium on the composite oxide support using a solution of a ruthenium salt, and then calcinating the support under a reducing gas atmosphere or an inert gas atmosphere (catalyst preparation step).

The ruthenium salt used in such a catalyst preparation step is not particularly limited, and it is possible to appropriately use acetates of ruthenium, carbonates of ruthenium, nitrates of ruthenium, ammonium salts of ruthenium, citrates of ruthenium, dinitro diammine salts of ruthenium, complexes of ruthenium (such as tetraammine complexes and carbonyl complexes), and the like. Further, the salt of such ruthenium is not particularly limited, and for example, triruthenium dodecacarbonyl (Ru₃(CO)₁₂), ruthenium chloride, ruthenium acetylacetonate, ruthenium nitrosyl nitrate, ruthenium nitrate, and the like can be mentioned as suitable ones.

Further, the solvent used for such a ruthenium salt solution (solution containing a ruthenium salt) is not particularly limited, and it is possible to appropriately use a solvent capable of forming ruthenium ions by dissolving the ruthenium salt. As such a solvent, for example, tetrahydrofuran (THF), water, alcohol, and the like can be used in embodiments. Note that the content of the ruthenium salt in such a solution is not particularly limited, and the amount (such as concentration) thereof may be appropriately changed according to the target amount of ruthenium supported.

Further, the method of supporting ruthenium on the composite oxide support using the ruthenium salt solution is not particularly limited, and for example, it is possible to employ a method in which the solution is brought into contact with the composite oxide support and then subjected to a drying treatment, to thereby support ruthenium on the composite oxide support. Further, the method of bringing the solution into contact with the support is not particularly limited, and examples of suitable methods include a method of impregnating the composite oxide support with the ruthenium salt solution, a method of adsorbing and supporting the ruthenium salt solution on the composite oxide support, and the like. Further, the method of the drying treatment is not particularly limited, and for example, a method may be employed in which the composite oxide support after contact with the solution is allowed to stand under a temperature condition of 50 to 150° C.

Further, when ruthenium is supported on the composite oxide support, it is contemplated to support ruthenium on the composite oxide support using the ruthenium salt solution so that the amount of ruthenium (metal) supported on the composite oxide support is 0.5 to 10 parts by mass (in embodiments, 1 to 5 parts by mass) in terms of metal of ruthenium based on 100 parts by mass of the composite oxide support.

Further, in the present disclosure, as described above, after ruthenium is supported on the composite oxide support, the support is calcinated in a reducing gas atmosphere or an inert gas atmosphere. In this way, by adjusting the atmosphere at the time of calcination to a reducing gas atmosphere or an inert gas atmosphere, ruthenium can be reduced to a metal state (metallic state) and supported on the support.

Note here that the “reducing gas atmosphere” refers to an atmosphere containing a reducing gas (such as hydrogen gas, carbon monoxide gas, and hydrocarbon gas), and examples thereof include an Ar gas atmosphere containing H₂ gas and an N₂ gas atmosphere containing H₂ gas. Note that such a reducing gas atmosphere is, in embodiments, an atmosphere composed of a gas mixture of a reducing gas and an inert gas (such as nitrogen and argon). Further, such a reduction gas atmosphere is, in embodiments, a gas atmosphere containing a reducing gas in a proportion of 1 to 30% by volume (in embodiments, 5 to 20% by volume). Additionally, as the reducing gas contained in such a reducing gas atmosphere, hydrogen gas is contemplated in embodiments. What is more, the “inert gas atmosphere” here means an atmosphere composed of an inert gas. Examples of such an inert gas include gases such as nitrogen, helium, neon, krypton, and argon.

In addition, from the viewpoint that ruthenium can be reduced to a metal state (metallic state) more efficiently, the atmosphere at the time of calcinating the support after supporting ruthenium is a reducing gas atmosphere in embodiments, and from the viewpoint of safety, an inert gas atmosphere is contemplated in embodiments. Further, when the reducing gas atmosphere is employed for calcinating the support after supporting ruthenium, from the viewpoint that ruthenium can be reduced to a metal state (metallic state) more efficiently, in embodiments, the reducing gas atmosphere is a gas atmosphere capable of hydrogen reduction (atmosphere containing hydrogen gas as the reducing gas).

Further, in the calcination under such a reducing gas atmosphere or inert gas atmosphere, the heating temperature is in embodiments, 200 to 500° C. (in embodiments, 300 to 500° C.). In addition, in the calcination under such a reducing gas atmosphere, the heating time varies depending on the heating temperature and cannot be unequivocally determined, but is, in embodiments, 0.5 to 10 hours, and, in embodiments, 1 to 3 hours. When the heating temperature and heating time at the time of calcination are less than the lower limit, it is not possible to sufficiently reduce all the ruthenium to the metal state (metallic state), and the ruthenium in the precursor state tends to remain. Meanwhile, when the upper limit is exceeded, the supported particles are sintered, making it difficult to support the metallic ruthenium in a sufficiently dispersed state, and the catalytic activity tends to decrease.

As has been described above, by supporting ruthenium on the composite oxide support, and then calcinating the support under a reducing gas atmosphere or an inert gas atmosphere, it is possible to obtain the ammonia synthesis catalyst of the present disclosure (an ammonia synthesis catalyst comprising: a composite oxide support containing cerium and praseodymium; and ruthenium supported on the composite oxide support, wherein a molar ratio of cerium to praseodymium ([cerium]/[praseodymium]) contained in the composite oxide support is 20/80 to 90/10).

[Method for Synthesizing Ammonia]

A method for synthesizing ammonia of the present disclosure is a method comprising: synthesizing ammonia by bringing a gas containing hydrogen and nitrogen into contact with the ammonia synthesis catalyst of the present disclosure.

Such a method for synthesizing ammonia of the present disclosure is not particularly limited except that the above-mentioned ammonia synthesis catalyst of the present disclosure is used as a catalyst, and for example, a method similar to a known method for synthesizing ammonia by bringing a gas containing hydrogen and nitrogen into contact with the catalyst may be employed except that the above-mentioned ammonia synthesis catalyst of the present disclosure is used as the catalyst.

Here, in the reaction for synthesizing ammonia from hydrogen and nitrogen, theoretically, 1 mol of nitrogen is reacted with 3 mol of hydrogen to obtain 2 mol of ammonia (N₂+3H₂→2NH₃). Therefore, as the “gas containing hydrogen and nitrogen” used in the method for synthesizing ammonia of the present disclosure, it is contemplated to use one in which the molar ratio of hydrogen to nitrogen (H₂/N₂) is 0.5/1 to 3/1 (in embodiments, 1.5/1 to 3/1). Further, the “gas containing hydrogen and nitrogen” used for the synthesis of ammonia may further contain inert gas (such as argon) as a carrier gas in addition to hydrogen gas and nitrogen gas, and from the viewpoint of increasing the amount of product (ammonia), it is contemplated to use a gas composed only of hydrogen gas and nitrogen gas in embodiments.

Further, the method of bringing the gas containing hydrogen and nitrogen into contact with the ammonia synthesis catalyst is not particularly limited, and it is possible to appropriately employ a known method capable of bringing the gas into contact with the catalyst. As the method of bringing a gas containing hydrogen and nitrogen into contact with an ammonia synthesis catalyst, it is possible to employ, for example, a method of bringing a gas containing hydrogen and nitrogen into contact with the ammonia synthesis catalyst by filling a sealable reaction vessel with the ammonia synthesis catalyst and then replacing the ambient gas in the reaction vessel with the gas containing hydrogen and nitrogen, a method of bringing a gas containing hydrogen and nitrogen into contact with the ammonia synthesis catalyst by placing the ammonia synthesis catalyst inside a gas flow tube and allowing the gas containing hydrogen and nitrogen to flow through the gas flow tube, and the like.

Further, in the case of the reaction of synthesizing ammonia by bringing a gas containing hydrogen and nitrogen into contact with the ammonia synthesis catalyst of the present disclosure, the reaction temperature is, in embodiments, 300 to 500° C., and in embodiments, 350 to 450° C., from the viewpoint that the higher the temperature, the lower the equilibrium concentration. Further, the pressure conditions for performing such a reaction are not limited, and it is contemplated to use a pressure of 0.1 to 10 MPa, and in embodiments, to use 1 to 8 MPa, because it enables a greater reduction in the energy required for ammonia production.

Note that according to the method for synthesizing ammonia of the present disclosure, ammonia can be synthesized more efficiently because the above ammonia synthesis catalyst of the present disclosure used as a catalyst has excellent ammonia production activity.

### EXAMPLES

Hereinafter, embodiments of the present disclosure will be described in more detail based on Examples and Comparative Examples, but the present claims are not limited by the following Examples.

### Example 1

First, cerium(III) nitrate hexahydrate, praseodymium(III) nitrate hexahydrate, and urea were dissolved in ion-exchanged water to obtain a solution for forming a composite oxide support. In the preparation of such a solution for forming a composite oxide support, cerium(III) nitrate hexahydrate and praseodymium(III) nitrate hexahydrate were used in such quantities that the total amount of the metal components, cerium (Ce) and praseodymium (Pr) (molar amount of Ce+molar amount of Pr), was 0.15 mol/L per liter of solution and the molar ratio of Ce to Pr (Ce/Pr) was 75/25. Further, in the preparation of such a solution for forming a composite oxide support, urea was used so that the content of urea in the solution was 2 mol/L (molar amount 13.3 times greater than the total molar amount of Ce and Pr in the solution).

Next, the solution for forming a composite oxide support was heated to 95° C. in the air and then stirred for 5 hours while maintaining the temperature at 95° C. to form a precipitate in the solvent. Subsequently, a treatment of suction filtration while washing with ion-exchanged water was applied to the precipitate in the solution to wash and collect the precipitate. Next, the obtained precipitate was dried at 100° C. overnight (12 hours) and then calcinated at 700° C. for 5 hours to obtain a composite oxide support containing Ce and Pr. Note that it is clear the molar ratio of Ce to Pr (Ce/Pr) in the composite oxide support obtained in this way is 75/25, originating from the composition of the solution for forming a composite oxide support described above.

Next, a THF solution was prepared by dissolving Ru₃(CO)₁₂ in tetrahydrofuran (THF) (concentration of Ru₃(CO)₁₂: 3 mmol/L), and the composite oxide support obtained as described above was impregnated with the THF solution. The solvent was then removed and ruthenium (Ru) was supported on the composite oxide support to obtain a catalyst precursor. Note that in the step of obtaining the catalyst precursor, the amount of the THF solution used was adjusted so that the amount of Ru supported based on 100 parts by mass of the composite oxide support in the finally obtained ammonia synthesis catalyst was 3 parts by mass in terms of Ru metal equivalent. Subsequently, the catalyst precursor was dried by maintaining the temperature at 70° C. for 12 hours. Next, the aforementioned catalyst precursor after drying was subjected to a calcination (heating) treatment (reduction treatment) at 300° C. for 1 hour under a reducing gas atmosphere composed of H₂ (10% by volume) and N₂ (90% by volume), to thereby obtain an ammonia synthesis catalyst including the composite oxide support containing Ce and Pr and Ru supported on the composite oxide support.

### Examples 2 to 4

Ammonia synthesis catalysts were obtained in the same manner as in Example 1 except that the amounts of cerium(III) nitrate hexahydrate and praseodymium(III) nitrate hexahydrate were changed so that the molar ratio of Ce to Pr (Ce/Pr) was 50/50 (Example 2), 25/75 (Example 3), and 90/10 (Example 4) in the preparation of a solution for forming a composite oxide support.

### Comparative Examples 1 to 5

Comparative ammonia synthesis catalysts were obtained in the same manner as in Example 1 except that the amounts of cerium(III) nitrate hexahydrate and praseodymium(III) nitrate hexahydrate were changed so that the molar ratio of Ce to Pr (Ce/Pr) was 100/0 (Comparative Example 1), 95/5 (Comparative Example 2), 10/90 (Comparative Example 3), 5/95 (Comparative Example 4), and 0/100 (Comparative Example 5) in the preparation of a solution for forming a composite oxide support.

### Comparative Example 6

Cerium(III) nitrate hexahydrate and praseodymium(III) nitrate hexahydrate were dissolved in ion-exchanged water to obtain a solution (A). Note that in the preparation of such a solution (A), cerium(III) nitrate hexahydrate and praseodymium(III) nitrate hexahydrate were used so that the total amount of Ce and Pr (molar amount of Ce+molar amount of Pr) was 0.2 mol/L per liter of solution and the molar ratio of Ce to Pr (Ce/Pr) was a Ce/Pr ratio of 95/5.

Next, a K₂RuO₄ aqueous solution (concentration of K₂RuO₄: 0.4 mol/L) was dissolved in a KOH aqueous solution (concentration of KOH: 2.0 mol/L) to obtain a solution (B). Note that in the preparation of such a solution (B), the amount of the K₂RuO₄ aqueous solution used was adjusted so that the amount of Ru supported based on 100 parts by mass of the composite oxide support in the finally obtained ammonia synthesis catalyst was 3 parts by mass in terms of Ru metal equivalent, and in addition, the amount of the KOH aqueous solution used was adjusted so that the amount of KOH was a molar amount that was 4.5 times the total molar amount of Ce and Pr in the solution (A).

Subsequently, while stirring the solution (A), the solution (B) was added dropwise to the solution (A) to obtain a mixed solution. Note that in such a mixed solution, a black precipitate was formed by dropwise addition of the solution (B). Subsequently, the mixed solution was heated to 60° C. and then stirred for 1 hour while maintaining the temperature at 60° C. After that, the precipitate precipitated in the mixed solution was washed with ion-exchanged water and suction-filtered to wash and collect the precipitate. Subsequently, the precipitate obtained in this way was dried at 85° C. overnight (12 hours) and calcinated at 500° C. for 1 hour to obtain a comparative ammonia synthesis catalyst (a catalyst in which the amount of Ru supported based on 100 parts by mass of the composite oxide support was 3 parts by mass in terms of Ru metal equivalent). Note that the method employed to produce the comparative ammonia synthesis catalysts was a method of coprecipitating Ru together with the metal components of the support (Ce and Pr), referring to the method described in Non-Patent Document 1 above.

### Performance Evaluation for Ammonia Synthesis Catalysts Obtained in Examples 1 to 4 and Comparative Examples 1 to 6

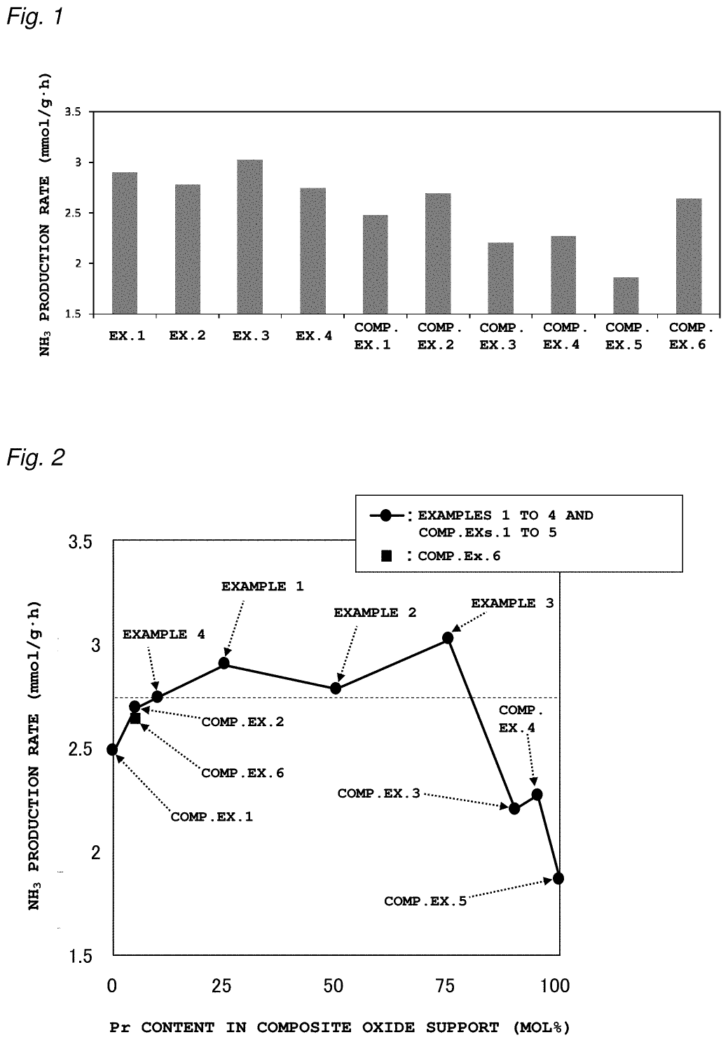

The ammonia synthesis catalysts obtained in Examples 1 to 4 and Comparative Examples 1 to 6 were used to determine the ammonia production rate of each catalyst as follows. Note that a fixed-bed flow reactor was used to measure the ammonia production rate. Additionally, in the measurement of the ammonia production rate, 0.2 g of ammonia synthesis catalyst was placed in the gas flow path of the reactor so that the gas introduced into the gas flow path (input gas) would go to the outlet of the gas flow path after coming into contact with the ammonia synthesis catalyst (after passing through the catalyst), and as the input gas, a gas containing H₂ and N₂ and with a molar ratio of H₂ to N₂ (H₂/N₂) of 3/1 was used. Thereafter, first, the ammonia synthesis catalyst was pretreated by maintaining the temperature at 600° C. for 2.5 hours while supplying the ammonia synthesis catalyst placed in the gas flow path with the input gas at a flow rate of 80 mL/min under atmospheric pressure (under a condition of 0.1 MPa). Subsequently, under atmospheric pressure, the heating temperature of the ammonia synthesis catalyst was lowered from 600° C. to 375° C. while the input gas was supplied under the same conditions (flow rate: 80 mL/min), and the ammonia synthesis catalyst was held at 375° C. for 1 hour. After that, the concentration of ammonia in the gas emitted from the outlet of the gas flow path (output gas) was measured to calculate the ammonia production rate per gram of catalyst. Note that the concentration of ammonia in the output gas was measured by IR spectroscopy. Table 1 and FIG. 1 show the obtained results. Further, FIG. 2 shows a graph presenting the relationship between the Pr content (mol %) in the composite oxide support of each catalyst and the ammonia production rate.

TABLE 1

| | Molar Ratio of | | | |
|---|---|---|---|---|
| | Ce to Pr in | | | |
| | Composite Oxide | | | NH₃ Production |
| | Support | | Amount of Ru | Rate |
| | Ce | Pr | Supported⁽*¹⁾ | (Unit: mmol/g · h) |
| Example 1 | 75 | 25 | 3 Parts by Mass | 2.90 |
| Example 2 | 50 | 50 | 3 Parts by Mass | 2.78 |
| Example 3 | 25 | 75 | 3 Parts by Mass | 3.02 |
| Example 4 | 90 | 10 | 3 Parts by Mass | 2.74 |
| Comparative | 100 | 0 | 3 Parts by Mass | 2.48 |
| Example 1 | | | | |
| Comparative | 95 | 5 | 3 Parts by Mass | 2.69 |
| Example 2 | | | | |
| Comparative | 10 | 90 | 3 Parts by Mass | 2.20 |
| Example 3 | | | | |
| Comparative | 5 | 95 | 3 Parts by Mass | 2.27 |
| Example 4 | | | | |
| Comparative | 0 | 100 | 3 Parts by Mass | 1.86 |
| Example 5 | | | | |
| Comparative | 95 | 5 | 3 Parts by Mass | 2.64 |
| Example 6 | | | | |

⁽*¹⁾The amount of Ru supported based on 100 parts by mass of the composite oxide support (Ru metal equivalent) [parts by mass]

As is clear from the results shown in Table 1 and FIGS. 1 and 2, the ammonia synthesis catalysts (Examples 1 to 4) using composite oxide supports with Pr content (molar ratio) in the range of 10 to 75 mol % based on the total molar amount of Ce and Pr all had ammonia production rates of 2.74 mmol/g·h or more per gram of catalyst. On the other hand, the comparative ammonia synthesis catalysts (Comparative Examples 1 and 2 and Comparative Example 6) using composite oxide supports with a Pr content (molar ratio) of 5 mol % or less based on the total molar amount of Ce and Pr all had ammonia production rates of 2.69 mmol/g·h or less per gram of catalyst, and the ammonia production activity was not sufficient compared to the ammonia synthesis catalysts obtained in Examples 1 to 4. In addition, the ammonia synthesis catalysts (Comparative Examples 3 to 5) using composite oxide supports with a Pr content (molar ratio) of 90 mol % or more based on the total molar amount of Ce and Pr had ammonia production rates of 2.27 mmol/g·h or less per gram of catalyst, and the ammonia production activity was still not sufficient compared to the ammonia synthesis catalysts obtained in Examples 1 to 4. The results of the ammonia production rates show that the ammonia synthesis catalysts (Examples 1 to 4) obtained in Examples 1 to 4 can achieve higher ammonia production activity even under conditions of 375° C. and 0.1 MPa.

The results also confirm that when the Pr content (molar ratio) based on the total amount of Ce and Pr in the composite oxide support is within the range of 10 to 75 mol % (when the molar ratio of Ce to Pr (Ce/Pr) is 25/75 to 90/10), it is possible to obtain a catalyst with enhanced ammonia production activity. Further, considering the measurement results of the ammonia production rates, it is clear that an ammonia synthesis catalyst in which Ru is supported on the composite oxide support with the molar ratio of Ce to Pr (Ce/Pr) of 20/80 to 90/10 can further improve the ammonia production efficiency.

Note that comparing Comparative Example 2 with Comparative Example 6, it was confirmed that although the method of catalyst production was different, the ammonia production rate was more improved when the coprecipitation method was used to produce the composite oxide support and then Ru was supported on the obtained composite oxide support to prepare the comparative ammonia catalyst (Comparative Example 2) than when Ru was coprecipitated together with Ce and Pr to prepare the comparative ammonia catalyst (Comparative Example 6), and it was also found that a higher level of ammonia production activity was possible to achieve by supporting Ru after the composite oxide support was produced by employing the coprecipitation method. Note that the present inventors presume that when Ru was coprecipitated together with Ce and Pr to prepare the comparative ammonia catalyst (Comparative Example 6), part of the Ru was incorporated into the support during calcination of the coprecipitate, resulting in fewer active sites when used as a catalyst, and this resulted in lower activity than the ammonia catalyst obtained in Comparative Example 2.

As described above, the present disclosure makes it possible to provide an ammonia synthesis catalyst having excellent ammonia production activity and enabling more efficient synthesis of ammonia, a method for producing an ammonia synthesis catalyst capable of efficiently producing the ammonia synthesis catalyst, and a method for synthesizing ammonia using the ammonia synthesis catalyst. As above, since the ammonia synthesis catalyst of the present disclosure is excellent in ammonia production activity, it is particularly useful as a catalyst or the like used when industrially producing ammonia.

What is claimed is:

1. An ammonia synthesis catalyst comprising:
a composite oxide support containing cerium and praseodymium; and
ruthenium supported on the composite oxide support, wherein
a molar ratio of cerium to praseodymium ([cerium]/[praseodymium]) contained in the composite oxide support is 20/80 to 90/10.

2. The ammonia synthesis catalyst according to claim 1, wherein the molar ratio of cerium to praseodymium ([cerium]/[praseodymium]) contained in the composite oxide support is 25/75 to 75/25.

3. A method for producing an ammonia synthesis catalyst, comprising:
obtaining a composite oxide support containing cerium and praseodymium by using a solution for forming a composite oxide support containing a cerium salt and a praseodymium salt in a proportion such that a molar ratio of cerium to praseodymium ([cerium]/[praseodymium]) is 20/80 to 90/10, producing a precipitate containing cerium and praseodymium in the solution by a coprecipitation method, and then calcinating the precipitate; and
obtaining the ammonia synthesis catalyst according to claim 1 by supporting ruthenium on the composite oxide support using a solution of a ruthenium salt, and then calcinating the support under a reducing gas atmosphere or an inert gas atmosphere.

4. The method for producing an ammonia synthesis catalyst according to claim 3, wherein the solution for forming a composite oxide support further contains urea in a molar amount that is 8 to 20 times a total molar amount of cerium and praseodymium contained in the solution.

5. A method for synthesizing ammonia, comprising: synthesizing ammonia by bringing a gas containing hydrogen and nitrogen into contact with the ammonia synthesis catalyst according to claim 1.
